(19) United States
(12) Patent Application Publication
(10) Pub. No.: US 2015/0324864 A1
(43) Pub. Date: Nov. 12, 2015

(54) METHOD AND SYSTEM OF ALLOCATING TO ADVERTISERS OF MARKETABLE COMMODITIES ON A DIGITAL ADVERTISING PORTAL A SHARE OF MARKETING PRESENCE AND/OR MARKETING OPPORTUNITIES

(71) Applicant: REA Group Ltd, Richmond, Victoria, OT (AU)

(72) Inventors: Henry Ruiz, Ivanhoe East (AU); Scott Pattison, Rosanna (AU)

(21) Appl. No.: 14/409,981

(22) PCT Filed: Jan. 14, 2013
(86) PCT No.: PCT/AU2013/000024

§ 371 Date: Dec. 19, 2014

(30) Foreign Application Priority Data
Jun. 29, 2012 (AU) 2012902772

(51) Int. Cl. G06Q 30/02; G06Q 30/06

(52) U.S. Cl. CPC G06Q 30/0273; G06Q 30/0625; G06Q 50/16

(57) ABSTRACT

A computer-implemented method of allocating to advertisers of marketable commodities on a digital advertising portal a share of marketing presence and/or marketing opportunities is disclosed. The commodities may be real estate properties. The method includes receiving from each advertiser one or more classified listings corresponding to marketable commodities, said classified listings including one or more commodity descriptors to allow for identification of said marketable commodities. A share of marketing presence and/or marketing opportunities on said digital advertising portal is then allocated to the advertisers, based upon at least said classified listings received from said advertiser. The share of marketing presence may be determined by calculating a listing value for each classified listing, based on a listing weighting associated with each classified listing. The classified listings may then be used to calculate respective advertiser values, on which the marketing share is based.

### FIELD OF THE INVENTION

The present invention relates generally to computerised information systems. In particular, the invention concerns a method and system of allocating to advertisers of marketable commodities on a digital advertising portal a share of marketing presence on that digital advertising portal and/or a share of marketing opportunities. The invention is particularly useful in relation to allocating to advertisers of real estate property a share of marketing presence on a digital advertising portal and/or a share of marketing opportunities in relation to real estate properties (e.g. new sales or rental leads in relation to real estate properties), and it will therefore be convenient to describe the invention in that environment. However, it should be understood that the invention may be implemented in other environments.

### BACKGROUND OF THE INVENTION

Digital advertising portals (e.g. Internet-based advertising portals that are commonly accessible via a data network from either fixed or mobile devices) are commonly used in relation to real estate property sales, real estate property leasing, the provision of real estate related information, vehicle and/or boating sales, and for advertising employment positions and opportunities. The majority of these digital advertising portals are highly reliant on the placement of classified advertisements (known as ‘classified listings’) by advertisers of marketable commodities (e.g. real estate properties, vehicles or boats) or employment opportunities, and the associated revenue collected from these advertisers in return for listing the classified advertisements on the digital advertising portal.

Marketing by advertisers on digital advertising portals, particularly online advertising portals concerned with real estate property sales and/or leasing, is primarily delivered through the classified listings placed by the advertisers. However, in more recent times, marketing by advertisers on digital advertising portals has also been made possible through the purchase of specific marketing products such as, for example, banner advertising. In most cases, the acquisition of such marketing products by advertisers is determined on a ‘first come first served’ basis or, alternatively, access to such marketing products is available to advertisers on a rotational basis. These systems for allocating access to marketing products on existing digital advertising portals do not accurately reflect the volume of advertising activities (i.e. the number of classified listings and associated advertising spend) of each of the advertisers. For example, an advertiser that places 50 classified listings on the digital advertising portal may have the same access (and entitlement) to the marketing products as an advertiser that places only 2 classified listings on the digital advertising portal.

### SUMMARY OF THE INVENTION

Accordingly, the present invention allows an operator of a digital advertising portal to manage the allocation of access to marketing products and/or services. More specifically, the present invention provides a value-based method and system of allocating to advertisers of saleable or marketable commodities (such as, for example, real estate properties, vehicles, boats, or employment opportunities) a share of marketing presence (e.g. access to marketing products) and/or marketing opportunities (e.g. leads in relation to the sale and/or rental of marketable commodities) on a digital advertising portal. These may be generated as a result of the digital advertising portal or by other means (e.g. offline lead generation).

The present invention recognises that advertisers significantly influence the relative success or failure of a digital advertising portal on which they advertise. This influence can be measured in a number of ways:
Revenue received in relation to classified listings—which can vary depending upon the number and/or type of classified listings (including associated listing upgrade product purchases) placed by each advertiser on the digital advertising portal;
Number of classified listings—as a digital advertising portal with a large volume of classified listings will generally be perceived by users as desirable (since the user will have a greater chance of locating relevant marketable commodities), and will therefore result in more traffic on the digital advertising portal, together with greater consumer engagement, activity and enquiry;
Quality of classified listings—it is generally the case that a digital advertising portal with higher quality classified listings (e.g. classified listings providing detailed and accurate information and/or images of a marketable commodity, or classified listings advertising marketable commodities of a higher quality) will generate more user interest and engagement.

As the value provided to the digital advertising portal by advertisers can vary significantly depending upon one or more of the above factors, the present invention acknowledges that the reward provided to each of these advertisers (in terms of their access or entitlement to, for example, marketing products on the digital advertising portal and access to potential buyer leads) should reflect the value provided to the digital advertising portal.

According to an aspect of the present invention, there is provided a computer-implemented method of allocating to advertisers of marketable commodities on a digital advertising portal a share of marketing presence and/or marketing opportunities, said method comprising the steps of:

(a) receiving from each of said advertisers one or more classified listings corresponding to marketable commodities; said classified listings including one or more commodity descriptors to allow for identification of said marketable commodities;
(b) calculating for each of said classified listings a listing value, said listing value being based upon at least a listing weighting associated with said classified listing;
(c) calculating for each of said advertisers at least one advertiser value, said advertiser value being based upon at least one or more of said listing values for classified listings associated with said advertiser; and
(d) determining for each of said advertisers a share of marketing presence and/or marketing opportunities on said digital advertising portal, said share of marketing presence and/or marketing opportunities being based upon at least said advertiser value.

The method is particularly useful in relation to allocating to advertisers of real estate properties a share of marketing presence and/or marketing opportunities on a digital advertising portal. However, it should be understood that the method could equally be used for allocating a share of marketing presence and/or marketing opportunities, on an online advertising portal, to advertisers of goods such as, for example, automobiles or boats, items of jewelry, antiques, paintings, and artwork, or advertisers of employment or career opportunities. However, in the embodiment of the invention described below, the marketable commodities are real estate properties.

The commodity descriptors may include one or more of a location of the real estate property, a classification of the real estate property, and a listing price for the real estate property. The location of the real estate property preferably includes the street address of the property. The classification of the real estate property may include property type information (such as, for example, whether the property is a house, unit, apartment, villa etc.) and/or sales type information (such as, for example, whether the property is advertised for sale, or advertised for rent). In addition, the commodity descriptors may also include information such as, for example, number of bedrooms, number of bathrooms, permitted land use, land size, age of property, parking (e.g., garage or carport, and number of spaces), internal floor area, number of levels, and level in the building.

According to the method, step (c) may also include the preliminary step of determining one or more search queries available to users of the digital advertising portal for identifying relevant marketable commodities. Preferably, the search queries available to the users include one or more of a desired property location, a desired property classification, and a desired range of property listing prices. The desired property location may be as broad as a desired state or region, or as narrow as a desired postcode, suburb, or even street with a given suburb. The desired property classification may include property type information (such as, for example, whether the property is a house, unit, apartment, villa etc.) and/or sales type information (such as, for example, whether the property is advertised for sale, or advertised for rent). The desired range of property listing prices may vary depending on the selection of desired property classification. For example, if the desired property classification is a ‘house’ that is ‘advertised for rent’, then the desired price range may be a provided as minimum and maximum values for the desired weekly rental amount. Alternatively, if the desired property classification is an ‘apartment’ that is ‘advertised for sale’, then the desired price range may be provided as minimum and maximum values for the desired purchase price.

The above step of determining one or more search queries available to users of the online advertising portal may be an automated process that involves determining available combinations of desired property location, desired property classification, and desired range of property listing prices. It a representative embodiment of the present invention, the determination of search queries available to users of the digital advertising portal may be conducted by reference to the classified listings (and particularly the commodity descriptors associated with the classified listings) received from the advertisers.

According to the method, and for each of the advertisers, step (c) may also include calculating an advertiser value corresponding to each of the search queries, wherein the advertiser value is based upon at least one or more of the listing values for a subset of classified listings associated with the advertiser. In addition, the advertiser value may be based upon a total of all the listing values for the subset of classified listing associated with the advertiser. The subset of classified listings may include all those classified listings associated with the advertiser that are also identifiable by the search query. The subset of classified listings may be determined based upon at least a comparison of the search query with the commodity descriptors for each of the classified listings. For example, the subset of classified listings may include all those classified listings (associated with a given advertiser) that have commodity descriptors including a ‘house’ property classification, and a location in the suburb of ‘Richmond’. Alternatively, the subset of classified listings may be the entire set of classified listings associated with a given advertiser.

The listing weighting, used to calculate the listing value for each of the classified listings, may be based upon one or more of a volume weighting amount, a listing upgrade weighting amount, and a consumer interest weighting amount. The volume weighting amount may simply represent the existence of a given classified listing or, in the event of multiple similar classified listings, may be used to represent the volume (i.e. total number) of such similar listings. The listing upgrade weighting may provide an indication as to the ‘quality’ or ‘value’ (to the advertiser) of the classified advertisement. In the majority of cases, the listing upgrade weighting may be determined based upon upgrade packages purchased by an advertiser in relation to a given classified advertisement. Upgrade packages may include, for example, visual upgrades that allow for larger or more detailed classified listings that contain colour images and floor plans, or search ranking priority upgrades that place the classified advertisement in a higher ranking (relative to other similar classified listings) when a search request is submitted by a user.

The consumer interest weighting amount, used in the calculation of the listing weighting, may be based upon performance data of comparable classified listings. The consumer interest weight amount assigned to a given classified advertisement represents the level of consumer (i.e. user) value, interaction or engagement that the classified advertisement is expected to generate on the digital advertising portal. For example, the consumer value or engagement may be measured by the number of inquiries generated by said classified advertisement, or the number of times (and/or duration of time for which) the classified advertisement is viewed. The consumer index weighting amount is preferably generated by reviewing the performance of similar classified listings (i.e. by analysis of various statistics representative of the success of the classified advertisement), and assigning a consumer index weighting amount similar to that of the similar classified listings. For example, a classified advertisement for a ‘house’ located in the suburb of Richmond, that had been advertised for 10 days, would be assigned a consumer index weighting amount based upon average user engagement performance data for other classified listings for houses located in the suburb of Richmond (after being advertised for 10 days).

The calculation of the advertiser value, for each of the advertisers, may also be based upon one or more of a maximum potential listing value for one or more classified listings associated with the advertiser, an amount of purchased advertiser value associated with the advertiser, and an amount of transferred advertiser value associated with the advertiser. In a representative embodiment of the present invention, the calculation of the advertiser value, for each of the advertisers, may also be based upon the percentage of classified listings that are sold (within a given period of time), and/or a percentage of these sales for which a sale price is disclosed. The maximum potential listing value for each of the one or more of the classified listings associated with the advertiser may be determined by applying at least the maximum listing upgrade weighting amount to each of the classified listings associated with the advertiser. In a representative embodiment of the present invention, the amount of purchased advertiser value may be represented in terms of a ‘points’ value. For example, an advertiser wishing to increase their share of marketing presence and/or marketing opportunities on the digital advertising portal in relation to a particular search query or combination may, as an alternative to increasing the number and/or quality of classified listings, purchase ‘points’ which directly influence their advertiser value in relation to that search query or combination. In a representative embodiment of the present invention, the amount of transferred advertiser value may also be represented in terms of a ‘points’ value. However, it should be understood that transferred advertiser value will only be applicable to those existing advertisers that have already been allocated a share of marketing presence and/or marketing opportunities. Furthermore, the ability of an advertiser to re-allocate or assign an amount of transferred advertiser value may require that the advertiser has previously associated at least a portion of their share of marketing presence and/or marketing opportunities to specific search query or combination. As such, the process of re-allocating or assigning (by distribution of an amount of transferred advertiser value) a portion of the share of marketing presence and/or marketing opportunities, may require transferring ‘points’ from one search query or combination to another.

The calculation of the share of marketing presence and/or marketing opportunities, for each of the advertisers, may also be based upon a comparison of the advertiser value with a total of the advertiser values for all of the advertisers. For example, the calculation of the share of marketing presence and/or marketing opportunities (for any given moment at which the calculation is performed) may be based upon a comparison of the advertiser value for a particular advertiser relative to the cumulative total of the advertiser values for all advertisers. As such, and only at the time of performing the calculation (or for a discrete time period e.g. 24 hours), the share of marketing presence and/or marketing opportunities for a particular advertiser may be expressed as a percentage of the total marketing presence and/or marketing opportunities on the digital advertising portal.

The determination of the share of marketing presence and/or marketing opportunities, for each of the advertisers, may be repeated at predefined time intervals such as, for example, on a daily basis. In a representative embodiment of the present invention, the determination of the share of marketing presence and/or marketing opportunities, for each of the advertisers, may be conducted at the conclusion of each business day. In accordance with an alternative embodiment of the present invention, the determination of the share of marketing presence and/or marketing opportunities, for each of the advertisers, may be conducted dynamically or in response to an activity by an advertiser that affects their share of marketing presence and/or marketing opportunities, or an activity by another advertiser that affects the advertiser's share of marketing presence and/or marketing opportunities.

According to the method, and for each of the advertisers, the share of marketing presence and/or marketing opportunities may influence one or more of a share of advertising space allocated to the advertiser on the digital advertising portal, a share of advertising frequency allocated to the advertiser on the digital advertising portal, a duration of advertising time allocated to the advertiser on the digital advertising portal, a search ranking of the classified listings associated with the advertiser relative to classified listings associated with other advertisers, and a share of potential consumer leads (e.g. leads in relation to the sale and/or rental of marketable commodities) allocated to the advertiser. The share of advertising space may represent a predefined advertisement area on a browser window (e.g. a banner advertisement) presented to a user accessing the digital advertising portal, and conducting a search for a desired marketable commodity. The share of advertising frequency may represent the number of times that the advertising and/or marketing material of a given advertiser is presented to users accessing the digital advertising portal. The duration of advertising time allocated to the advertiser may represent the overall advertising time allocated to an advertiser within a given time period, and/or advertising time allocated to an advertiser within a given user session on the digital advertising portal. The share of marketing presence and/or marketing opportunities may also influence the search ranking of the classified listings associated with an advertiser. For example, and assuming two or more similar classified listings, the classified listings associated with an advertiser having a greater share of marketing presence and/or marketing opportunities will rank higher in search results than the classified listings associated with an advertiser having a lower share of marketing presence and/or marketing opportunities. While not necessarily the result of users accessing the digital advertising portal to conduct searching for marketable commodities, the share of marketing presence and/or marketing opportunities may also influence the share of potential buyer leads allocated to an advertiser. For example, if a digital advertising portal allows users to register an interest in present or forthcoming marketable commodities that align with a given search query, then the contact details of such users may be provided to advertisers based upon their respective share of marketing presence and/or marketing opportunities.

According to a further aspect of the present invention, there is provided a computer-implemented system of allocating to advertisers of marketable commodities on a digital advertising portal a share of marketing presence and/or marketing opportunities, said system comprising:

(a) means for receiving from each of said advertisers one or more classified listings corresponding to marketable commodities; said classified listings including one or more commodity descriptors to allow for identification of said marketable commodities;
(b) means for calculating for each of said classified listings a listing value, said listing value being based upon at least a listing weighting associated with said classified listing;
(c) means for calculating for each of said advertisers at least one advertiser value, said advertiser value being based upon at least one or more of said listing values for classified listings associated with said advertiser; and
(d) means for determining for each of said advertisers a share of marketing presence and/or marketing opportunities on said digital advertising portal, said share of marketing presence and/or marketing opportunities being based upon at least said advertiser value.

According to a still further aspect of the present invention, there is provided a computer-implemented method of determining the composition of advertising information presented to users of a digital advertising portal, said advertising portal comprising advertising information relating to one or more marketable commodities, said method comprising the steps of:

(a) receiving from each of said advertisers one or more classified listings corresponding to marketable commodities; said classified listings including one or more commodity descriptors to allow for identification of said marketable commodities;
(b) determining one or more search queries available to said users of said digital advertising portal for identifying relevant marketable commodities
(c) receiving from at least one of said users a search request, said search request including at least one of said search queries available to said users;
(d) allocating to each of said advertisers a share of advertising presence on said digital advertising portal, said share of advertising presence being based upon at least said classified listings received from said advertiser; and
(e) presenting to each of said users a selection of advertising information, said advertising information being based upon said share of advertising presence allocated to each of said advertisers and/or said search request.

According to a still further aspect of the present invention, there is provided a computer-implemented method of allowing advertisers of marketable commodities to manage a share of marketing presence and/or marketing opportunities on a digital advertising portal, said method comprising the steps of:

(a) receiving from each of said advertisers one or more classified listings corresponding to marketable commodities; said classified listings including one or more commodity descriptors to allow for identification of said marketable commodities;
(b) allocating to each of said advertisers a share of marketing presence and/or marketing opportunities on said digital advertising portal, said share of marketing presence and/or marketing opportunities being based upon at least said classified listings received from said advertiser;
(c) presenting to one or more of said advertisers marketing share data, said marketing share data being representative of said share of marketing presence and/or marketing opportunities allocated to said advertiser; and
(d) receiving a request from one or more of said advertisers to modify said share of marketing presence and/or marketing opportunities on said digital advertising portal.

According to a still further aspect of the present invention, there is provided a computer-implemented method of allocating to advertisers of marketable commodities on a digital advertising portal a share of marketing presence and/or marketing opportunities, said method comprising the steps of:

(a) receiving from each of said advertisers one or more classified listings corresponding to marketable commodities; said classified listings including one or more commodity descriptors to allow for identification of said marketable commodities; and
(b) allocating to each of said advertisers a share of marketing presence and/or marketing opportunities on said digital advertising portal, said share of marketing presence and/or marketing opportunities being based upon at least said classified listings received from said advertiser.

According to a still further aspect of the present invention, there is provided a computer-implemented system of allocating to advertisers of marketable commodities on a digital advertising portal a share of marketing presence and/or marketing opportunities, said system comprising one or more computers including:

at least one processor;
an interface between said processor and a data network;
a database for containing information relating to said marketable commodities; and
at least one storage medium operatively coupled to said processor, said storage medium containing program instructions for execution by said processor, said program instructions causing said processor to execute the steps of any one of the above methods.

According to a still further aspect of the present invention, there is provided a tangible computer-readable medium having computer-executable instructions stored thereon for directing a programmable device to perform any one of the above methods.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents.

For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

FIG. 1 shows a schematic block diagram of a system of allocating to advertisers of real estate properties a share of marketing presence and/or marketing opportunities on a digital advertising portal, in accordance with a representative embodiment of the present invention.

FIG. 2 is a flow chart illustrating a preferred method of allocating to advertisers of real estate properties a share of marketing presence and/or marketing opportunities on a digital advertising portal in accordance with the present invention.

FIG. 3 illustrates an example of a search results page presented to a user of the digital advertising portal in response to a submitted search query for a real estate property.

FIG. 4 illustrates an example of a search results page presented to a user of the digital advertising portal in response to a real estate agent or agency search submitted by the user.

FIG. 5 illustrates an example of a search results page presented to a user of the digital advertising portal in response to a submitted search query for a real estate property.

FIG. 6 illustrates an example of a marketing presence and/or marketing opportunities reporting screen presented to an advertiser accessing the digital advertising portal;

FIG. 7 illustrates an example of a marketing share increase screen presented to an advertiser accessing the digital advertising portal; and

FIG. 8 illustrates an example of a marketing share transfer screen presented to an advertiser accessing the digital advertising portal; and

FIG. 9 illustrates an example of advertiser profile screen presented to an advertiser accessing the digital advertising portal.

### DETAILED DESCRIPTION

Representative embodiments of the present invention relate to a computer-implemented method of allocating to advertisers of marketable commodities a share of marketing presence and/or marketing opportunities (referred to collectively as ‘share of voice’) on a digital advertising portal. The invention is particularly useful in relation to allocating to advertisers of real estate property a share of marketing presence and/or marketing opportunities on a digital advertising portal (e.g. Internet-based advertising portals that are commonly accessible via a data network from either fixed or mobile devices), and it will therefore be convenient to describe the invention in that environment. However, it should be understood that the invention is not limited to this preferred embodiment, and may be implemented in other environments such, for example, automobile and boating sales, and employment opportunities.

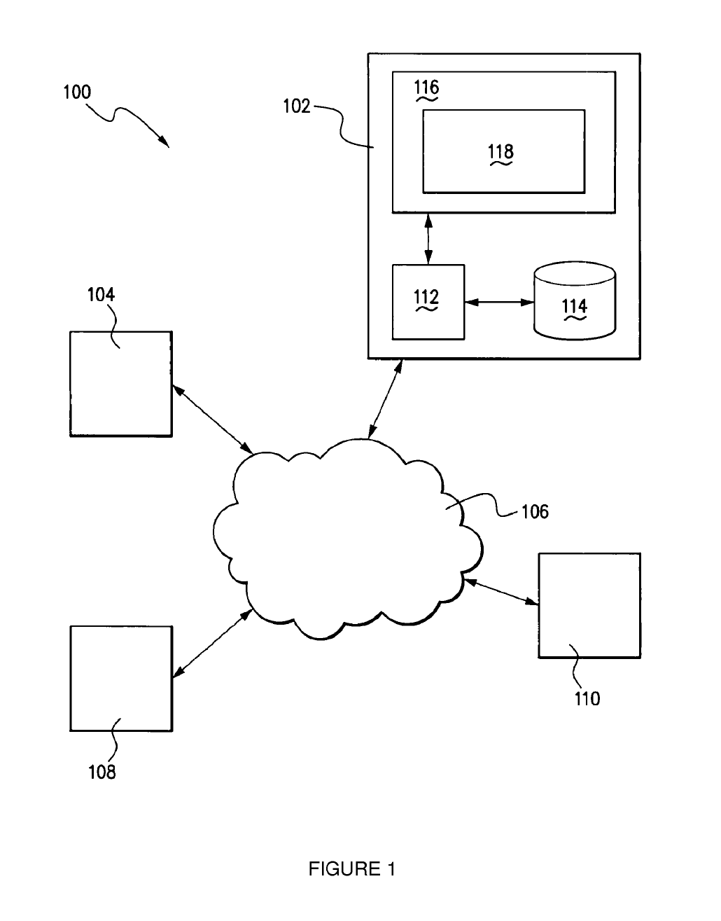

FIG. 1 illustrates an exemplary system 100 in which preferred embodiments of the invention may be implemented. The system includes a server 102 and at least one user terminal 104, both of which are connected to a network 106, which may be, for example, the Internet. Also connected to the network 106 are a plurality of user terminals and/or servers, e.g. 108, 110. It will be appreciated that FIG. 1 depicts the system 100 schematically only, and is not intended to limit the technology employed in the servers, user terminals and/or communication links. The user terminals in particular may be wired or wireless devices, and their connections to the network may utilize various technologies and bandwidths. For example, applicable user terminals include (without limitation): PC's with wired (e.g. LAN, cable, ADSL, dial-up) or wireless (e.g. WLAN, cellular) connections; and wireless portable/handheld devices such as PDA's, Apple iPads, or mobile/cellular telephones and smartphones. These devices also may include input means, such as a mouse and keyboard, stylus or other pointing device or system, or a touch screen, to enable the users to make selections and input data. The protocols and interfaces between the user terminals and the servers may also vary according to available technologies, and include (again without limitation): wired TCP/IP (Internet) protocols; GPRS, WAP and/or 3G protocols (for handheld/cellular devices); Short Message Service (SMS) messaging for digital mobile/cellular devices; and/or proprietary communications protocols.

The server 102 includes at least one processor 112 as well as a database 114, which would typically be stored on a secondary storage device of the server 102, such as one or more hard disk drives. Server 102 further includes at least one storage medium 116, typically being a suitable type of memory, such as random access memory, for containing program instructions and transient data related to the operation of the valuation system as well as other necessary functions of the server 102. In particular, memory 116 contains a body of program instructions 118 implementing the method and system in accordance with preferred embodiments of the invention. The body of program instructions 118 includes instructions for allocating to advertisers of real estate properties a share of marketing presence and/or marketing opportunities on a digital advertising portal, the operation of which will be described hereafter. It should be appreciated in relation to the configuration of the server 102 that one or more of the database 114, storage medium 116, and body of program instructions 118, may be provided at a remote location (such as for a cloud computing configuration).

It should be appreciated that the hardware used to implement the method of the invention may be conventional in nature or specifically designed for the purpose. The hardware structure shown in FIG. 1 is merely one possible embodiment and any other suitable structure may be utilised.

In a representative embodiment of the present invention, the method and system of allocating to advertisers of marketable commodities a share of marketing presence and/or marketing opportunities, require the existence of a digital advertising portal. Such digital advertising portals (i.e. Internet-based advertising portals that are commonly accessible via a data network) are well known and commonly used in relation to real estate property sales (e.g. realestate.com.au), real estate property leasing, vehicle and/or boating sales, and for advertising employment positions and opportunities. The majority of these digital advertising portals are highly reliant on the placement of classified advertisements (known as ‘classified listings’) by advertisers of marketable commodities (e.g. real estate properties, vehicles or boats) or employment opportunities, and the associated revenue collected from these advertisers in return for listing the classified advertisements on the digital advertising portal.

In relation to a preferred embodiment of the present invention, wherein the marketable commodities are real estate properties, the majority of the advertisers are likely to be real estate agents and/or real estate agencies as these parties are generally responsible for a large number of real estate properties (either for sale or for lease). Real estate agents and/or real estate agencies have an interest in promoting and increasing their marketing activities on digital advertising portals as there is generally a strong correlation between the share of marketing presence and the number of successful sales/placements.

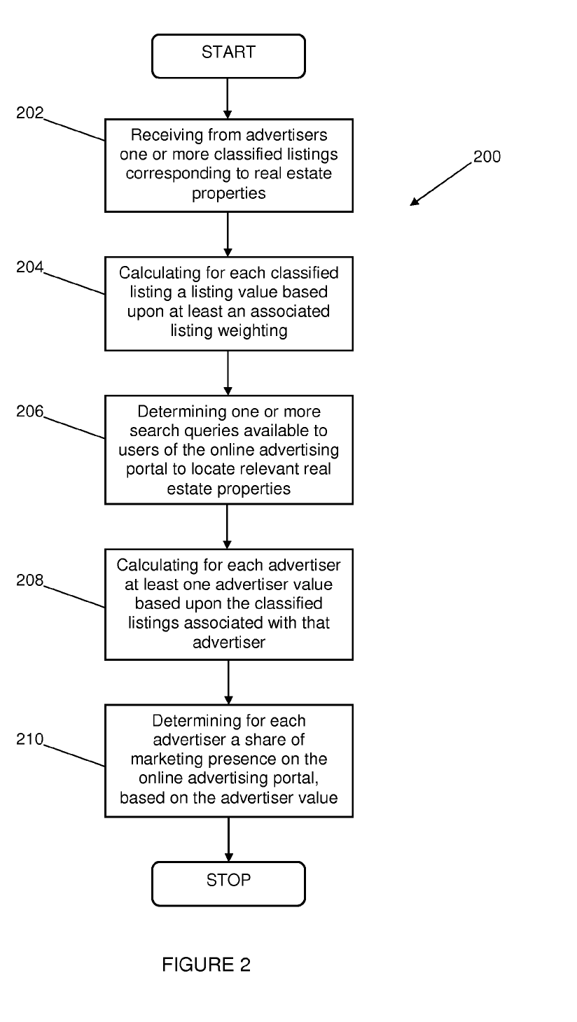

FIG. 2 is a flow chart 200 which illustrates a preferred method of allocating to advertisers of real estate properties a share of marketing presence and/or marketing opportunities on a digital advertising portal in accordance with the present invention. At step 202, the method includes receiving from advertisers (such as, for example, real estate agents and/or real estate agencies) one or more classified listings, each listing corresponding to a real estate property that is either being advertised for sale or advertised for lease (i.e. a rental property). Each of these classified listings also includes one or more commodity descriptors which allow for identification of the real estate property.

According to a representative embodiment of the present invention, the commodity descriptors include a location of the real estate property, a classification of the real estate property, and a listing price for the real estate property. The location of the real estate property preferably includes the street address of the property, so that potential purchasers/lessees are able to identify the property. In addition, it is expected that the street address of the property will also provide information such as the suburb, postcode and state in which the real estate property is located. The classification of the real estate property preferably includes property type information (such as, for example, whether the property is a house, unit, apartment, villa etc.) and/or sales type information (such as, for example, whether the property is advertised for sale, or advertised for lease). In addition, the commodity descriptors may also include information such as, for example, number of bedrooms, number of bathrooms, permitted land use, land size, age of property, parking (e.g., garage or carport, and number of spaces), internal floor area, number of levels, and level in the building. Finally, the listing price for the real estate property will depend upon the sales and classification information for the real estate property. For example, if the real estate property is being advertised for lease (i.e. a rental property) then the listing price will generally be provided as a weekly or monthly rental amount requested by the lessor of the property. Alternatively, if the real estate property is being advertised for sale, then the listing price will generally be provided as minimum sale price that would be considered by the vendor of the property.

As the classified listings are received from advertisers, the listing information and associated commodity descriptors are preferably stored within a centralised database 114. This data is then used by the digital advertising portal to create online classified listings (i.e. electronic versions of the classified listings) that can be viewed by users of the digital advertising portal. It should also be appreciated that in certain circumstances, the commodity descriptors received from the advertisers may be supplemented by accessing commercially available real estate databases, which contain a variety of property and sales information. However, it should be understood that the present invention is not intended to include the development of such a database. In accordance with a representative embodiment of the present invention, the digital advertising portal provides a searching facility that allows users to locate relevant real estate properties based upon one or more search criteria. As later described in greater detail, the search criteria available to users of the digital advertising portal preferably include one or more of a desired property location, a desired property classification, and a desired range of property listing prices.

It should be understood that while step 202, of receiving one or more classified listings from advertisers, has been illustrated in FIG. 2 as the first step in the flow chart 200, it is expected that the digital advertising portal will be adapted to receive classified advertisements from advertisers at any time due to the dynamic nature of the method of the present invention. As such, the allocation of share of marketing presence and/or marketing opportunities to advertisers of real estate properties is preferably a repeating process that occurs at regular or fixed time intervals (e.g. every 12 or 24 hours). However, it should be appreciated that, for each repetition, the allocation of share of marketing presence and/or marketing opportunities to advertisers of real estate properties is based upon the classified advertisements received by the digital advertising portal up until the time that the allocation is performed.

At step 204, the method involves calculating for each of the classified listings received from advertisers a listing value, which is effectively a point value assigned to each of the classified listings. The calculation of the listing value for each of the classified listings includes one of more of the following factors:
a volume weighting value or amount for the classified listing, which preferably indicates whether a classified listing exists (e.g. a value of 1 representing that a listing exists and is current, or a value of 0 representing that a listing no longer exists or is not presently being advertised);
a listing upgrade weighting amount for the classified listing, which is based upon one or more upgrade weightings (depending upon the upgrades available for a particular classified listing), wherein each upgrade weighting represents:
   whether an advertiser has selected an upgrade to be applied to the classified listing (e.g. a value of 0 if the upgrade has not been selected, or a value of 1 if the upgrade has been selected); and
   for each of the upgrades that have been selected by an advertiser, the level of the upgrade that has been selected (e.g. a value of 1 for a level 1 upgrade, a value of 2 for a level 2 upgrade, and a value of 3 for a level 3 upgrade).
a consumer interest weighting amount (referred to as a “consumer index”), which is a value assigned to a classified listing (preferably by the digital advertising portal) based upon the perceived level of consumer value, interaction or engagement that the classified listing generates on the digital advertising portal (e.g. the number of enquiries generated or the number of times that a particular classified listing is viewed).

The value of the listing upgrade weighting amount will depend upon the number and type of upgrades available for a particular classified listing, and it is envisaged that any number of upgrades could be applied to a classified listing. For example, possible upgrades include a search ranking priority upgrade, which improves the ranking of the classified listing (relative to other listings) for a given user search query, and a visual upgrade, which may allow for an improved appearance of the classified listing to include features such as colour photographs, floor plans, larger sizes images, virtual tour options etc. The value of the listing upgrade weighting amount will also be affected by factors such as, for example, the duration of time for which a particular upgrade is to be applied to the listing.

The consumer interest weighting amount is essentially a measure of the performance of a classified listing based upon one or more consumer interaction events such as, for example, the number of user views of the listing details, the number of user vies of the listing photographs, the number of enquiries generated as a result of the listing, and the number of times the URL to the classified listing is saved or “bookmarked”. The consumer index weighting amount is a relative measure that is preferably generated by reviewing the performance of similar classified listings (i.e. by analysis of various statistics representative of the success of the classified advertisement), and assigning a consumer interest weighting amount similar to that of the similar classified listings. For example, a classified advertisement for a ‘house’ located in the suburb of Richmond, that had been advertised for 10 days, would be assigned a consumer index weighting amount based upon average user engagement performance data for other classified listings for houses located in the suburb of Richmond (after being advertised for 10 days).

An example of how the consumer interest weighting amount may be calculated for a particular classified listing is shown below in Table 1. This example takes into consideration the value of certain designated consumer event (e.g. the number of user views of the listing details, the number of user views of the listing photographs, the number of enquiries generated as a result of the listing, and the number of times the URL to the classified listing is saved or “bookmarked”) relating to a classified listing for a 4 bedroom house in Toorak that has been listed for 7 days, and compares these to average values of the same consumer events for other 4 bedroom houses in Toorak when they had been listed for 4 days. In this particular case, the calculated value of the consumer interest weighting amount is 1.3, which signifies that the particular classified listing is has generated more consumer interest than other classified listings for comparable real estate properties.

TABLE 1

| | Average | | | | | | | |
|---|---|---|---|---|---|---|---|---|
| | | | Average | | Single listing | | | |
| | Consumer | Event | Consumer | | Consumer | Event | Consumer | |
| | Events | Value | Value | | Events | Value | Value | |
| view of details | 135.6 | 1 | 135.6 | | 182 | 1 | 182 | |
| photo views | 20.1 | 1 | 20.1 | | 25 | 1 | 25 | |
| bookmark/save | 3.4 | 2 | 6.8 | | 4 | 2 | 8 | |
| share | 1.8 | 2 | 3.6 | | 3 | 2 | 6 | |
| enquiries | 2.2 | 3 | 6.6 | | 4 | 3 | 12 | |
| Total | | | 172.7 | | | | 233 | |
| | | | | *(100%) | | | 1.3 | *(135%) |

In a representative embodiment of the present invention, the volume weighting amount, the listing upgrade weighting amount, and the consumer interest weighting amount (including all of the relating to similar real estate properties used in the calculation of the consumer interest weighting amount) are stored in the database 114. It should also be understood that one or more of these amounts may be updated in the database 114 at regular intervals (e.g. depending on the age of a particular classified advertisement), or as a result of predetermined events (e.g. upgrade purchases by an advertiser).

The calculation of the listing value for each of the classified listings is preferably performed at regular or fixed time intervals (e.g. every 12 or 24 hours) following the initial receipt of the classified listing from the advertiser. In accordance with a representative embodiment of the present invention, this calculation is performed in accordance with the following formula (which, for example, is based upon a total of two possible upgrades, namely Upgrade A and Upgrade B):

$$Listing Value = ( 1 \times volume weighting amount ) + ( 1 \times listing upgrade weighting ) + ( Upgrade A value \times Upgrade A weighting ) + ( Upgrade B value \times Upgrade B weighting ) + ( Consumer Interest weighing amount ) \qquad Formula 1$$

At step 206, the method further involves calculating for each of the advertisers at least one advertiser value, which is effectively a point value assigned to each of the advertisers based upon the listing values for classified listings associated with that advertiser. In a preferred embodiment of the present invention, and for each given advertiser, step 206 involves retrieving from the database 114 all classified listings that are associated with a particular advertiser and, more specifically, the calculated listing values associated with those classified listings. The first step of calculating the advertiser value is then to determine the total of all listing values retrieved from the database 114.

As preliminary step, the method at step 206 preferably involves determining the search queries that are actually available to users of the digital advertising portal at any given time, or at least at a time immediately prior to the allocation of share of marketing presence and/or marketing opportunities to advertisers. The search queries available to users of the digital advertising portal include one or more of a desired property location, a desired property classification, and a desired range of property listing prices. The desired property location may be as broad as a desired state or region, or as narrow as a desired postcode, suburb, or street with a given suburb. The desired property classification may include property type information (such as, for example, whether the property is a house, unit, apartment, villa etc.) and/or sales type information (such as, for example, whether the property is advertised for sale, or advertised for rent). The desired range of property listing prices may vary depending on the selection of desired property classification. For example, if the desired property classification is a ‘house’ that is ‘advertised for rent’, then the desired price range may be a provided as minimum and maximum values for the desired weekly rental amount. Alternatively, if the desired property classification is an ‘apartment’ that is ‘advertised for sale’, then the desired price range may be provided as minimum and maximum values for the desired purchase price.

In its most basic form, the preliminary step of determining the available search queries is an automated process that involves generating all possible combinations of desired property location, desired property classification, and/or desired range of property listing prices. Alternatively, the determination of search queries available to users of the digital advertising portal may be conducted by reference to the classified listings (and particularly the commodity descriptors associated with the classified listings) received from the advertisers.

In an alternate embodiment of the present invention, the method (at step 206) involves calculating for each advertiser an advertiser value for each of the search queries available to users of the digital advertising portal for identifying relevant real estate properties. Again, this would require the preliminary step of determining the search queries that are actually available to users of the digital advertising portal. However, and particularly for this alternate embodiment of the invention, the method, at step 206, may consider search queries for which there are current classified listings (and associated commodity descriptor information stored in the database 114), as well as search queries for which there are no current classified listings.

According to this alternate embodiment, once a determination has been made regarding the number of search queries available to users, it is then possible to calculate the advertiser values for each advertiser, and for each of the available search queries (including specifically search query combinations). For each given advertiser and for each identified search query, step 206 involves retrieving from the database 114 classified listings that are both associated with that particular advertiser and which meet with the particular search query. More specifically, and for each of these classified listings (i.e. those classified listings associated with that particular advertiser and which meet with the particular search query), the method at step 206 involves retrieving the calculated listing value from the database 114. The first step of calculating the advertiser value is then to determine the total of all listing values retrieved from the database 114.

In accordance with the preferred embodiment of the invention, described above, the calculation of the advertiser value (at step 206) then involves calculating an adjusted combined total of all listing values associated with a given advertiser, based upon the upgrades purchased or selected by that advertiser. For each advertiser, the adjusted combined total of all listing values is determined by calculating the number of classified listings (associated with that advertiser) that have been upgraded as a percentage of the total classified listings associated with that advertiser. For example, if a particular advertiser had a total of five classified listings, but only three of these classified listings have been upgraded beyond a base level listing, then the advertiser upgrade weighting would be 60% and, as a result, an additional 60% of the combined total of all listing values (associated with that advertiser) would be added to that combined total of all listing values. It should also be appreciated that the adjusted combined total of all listing values may be determined based upon an upgrade weighting, which is preferably determined by the digital advertising portal. Using the same example of an advertiser with three of five upgraded classified listings, an upgrade weighting of 0.5 would result in only 30% of the combined total of all listing values (associated with that advertiser) being added to the combined total of all listing values.

The adjusted combined total of all listing values associated with a given advertiser may also be determined by considering the combined total of all listing values associated with a given advertiser as a percentage of the maximum potential listing value (as a total value) for all classified listings associated with that advertiser. The maximum potential listing value assumes that all upgrades, at the highest level, are purchased or selected for the classified listings associated with that advertiser. By way of example, if an advertiser had five classified listings with a total maximum potential listing value of 90 points but, as a result of the actual upgrades purchased, the combined total of all listing values was only 23, then the percentage calculation would be approximately 26% (i.e. 23 of a possible 90 points). In this example, an additional 26% of the combined total of all listing values (associated with that advertiser) would then be added to that combined total of all listing values. It should also be appreciated that the adjustment of the combined total of all listing values, based upon the maximum potential listing value, may be determined based upon a listing potential weighting, which is preferably determined by the digital advertising portal. Using the same example of an advertiser having a combined total of all listing values of 23 points (from a possible 90 points), a listing potential weighting of 0.5 would result in only 13% of the combined total of all listing values (associated with that advertiser) being added to the combined total of all listing values.

The calculation of the advertiser value, for each of the advertisers, may also take into consideration an amount of purchased advertiser value associated with a particular advertiser, and/or an amount of transferred advertiser value (either positive or negative depending on the nature of the transfer) associated with that advertiser. However, the application of any purchased or transferred advertiser value generally assumes that at least one calculation regarding the share of marketing presence and/or marketing opportunities for that advertiser has already been performed.

In a representative embodiment of the present invention, the amount of purchased advertiser value is also represented in terms of a ‘points’ value. For example, an advertiser wishing to increase their total share of marketing presence and/or marketing opportunities on the digital advertising portal, and/or their specific share of marketing presence and/or marketing opportunities in relation to a particular search query or combination may, as an alternative to increasing the number and/or quality of classified listings, purchase ‘points’ which directly influence their advertiser value in relation to that search query or combination. Similarly, the amount of transferred advertiser value may also be represented in terms of a ‘points’ value. However, it should be understood that transferred advertiser value will only be applicable to those existing advertisers that have already been allocated a share of marketing presence and/or marketing opportunities. Furthermore, the ability of an advertiser to re-allocate or assign an amount of transferred advertiser value may require that the advertiser has previously assigned at least a portion of their share of marketing presence and/or marketing opportunities to specific search query or combination (e.g. 4-bedroom houses located in the suburb of Toorak). As such, the process of re-allocating or assigning (by distribution of an amount of transferred advertiser value) a portion of the share of marketing presence and/or marketing opportunities, preferably involves transferring ‘points’ from one search query or combination to another. As with the calculation of the listing value for each of the classified listings, the calculation of the advertiser value (for each advertiser) is preferably performed at regular or fixed time intervals (e.g. every 12 or 24 hours). In accordance with a representative embodiment of the present invention, this calculation is performed in accordance with the following formula:

$$Formula 2$$

$$Advertiser Value = For all classified listings associated with the Advertiser \text{:} \sum Listing Value x ( 1 + ( \# listings upgraded as a \% of \# total Advertiser listings ) \times listing upgrade weighting ) + ( ( 1 - ( \sum Listing Value / \sum Maximum Potential Listing Value ) ) \times listing potential weighting ) ) + Purchased Advertiser Points + Transferred ( In ) \text{Advertiser Points} - \text{Transferred} ( Out ) Advertiser Points$$

The calculation of the advertiser value, for each of the advertisers, then involves adding any purchased advertiser value or “points” to the adjusted combined total of all listing values, and adding or subtracting any transferred advertiser value (if such a transfer has been requested by an advertiser).

At step 208, and following the calculation of the advertiser value for each of the advertisers, the method involves determining the share of marketing presence and/or marketing opportunities for each of the advertisers. For each of the advertisers, the share of marketing presence and/or marketing opportunities is calculated by comparing the advertiser value to the total of the advertiser values for all advertisers, and expressing the advertiser value as a percentage of the total of the advertiser values. In accordance with a representative embodiment of the present invention, this calculation is performed in accordance with the following formula:

Share of Marketing Presence or Marketing Opportunities=For each Advertiser: Advertiser Value/ΣAll Advertiser Values Formula 3

The calculation of the share of marketing presence and/or marketing opportunities (for any given moment at which the calculation is performed) may be based upon a comparison of the advertiser value for a particular advertiser relative to the cumulative total of the advertiser values for all advertisers. As such, and only at the time of performing the calculation, the share of marketing presence and/or marketing opportunities for a particular advertiser may be expressed as a percentage of the total marketing presence and/or marketing opportunities on the digital advertising portal.

The determination of the share of marketing presence and/or marketing opportunities, for each of the advertisers, is preferably repeated at predefined time intervals such as, for example, on a daily basis. In a representative embodiment of the present invention, the determination of the share of marketing presence and/or marketing opportunities, for each of the advertisers, may be conducted at the conclusion of each business day. In accordance with an alternative embodiment of the present invention, the determination of the share of marketing presence and/or marketing opportunities, for each of the advertisers, may be conducted dynamically, in response to an activity by an advertiser that affects their share of marketing presence and/or marketing opportunities, or in response to an activity by another advertiser that affects the advertiser's share of marketing presence and/or marketing opportunities.

According to the method described in relation to steps 202 to 208, and for each of the advertisers, the share of marketing presence and/or marketing opportunities may influence one or more of a share of advertising space allocated to the advertiser on the digital advertising portal, a share of advertising frequency allocated to the advertiser on the digital advertising portal, a duration of advertising time allocated to the advertiser on the digital advertising portal, a search ranking of the classified listings associated with the advertiser relative to classified listings associated with other advertisers, and a share of potential buyer leads allocated to the advertiser. However, it should be appreciated that the actual influence of the marketing presence and/or marketing opportunities may vary in accordance with advertiser demands, and/or requirements of users or the digital advertising portal.

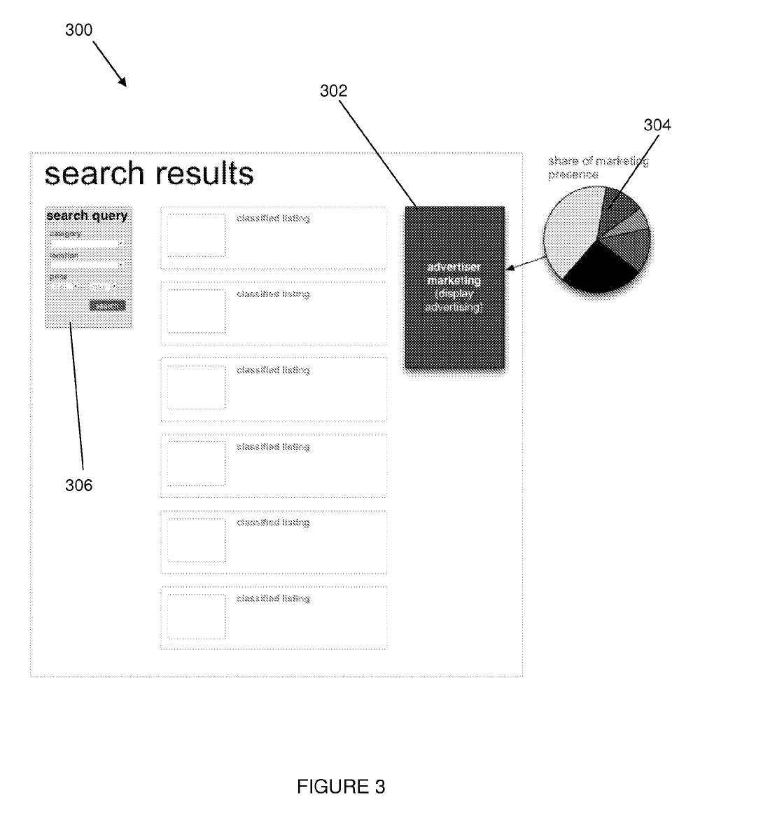

The share of advertising space preferably represents a predefined advertisement area on a browser window (e.g. a banner advertisement) presented to a user accessing the digital advertising portal, and conducting a search for a desired marketable commodity. Advertisers' marketing and advertising information is commonly presented to users of a digital advertising portal together with the search results, after executing a classified search (i.e. submitting a search query. Following the determination of the share of marketing presence and/or marketing opportunities for each of the advertisers, the presentation of advertiser information (e.g. marketing and/or advertising information) on the search results page may be determined based upon the search query entered by the user and, more importantly, the share of marketing presence and/or marketing opportunities allocated to that search query (or search query combination) by the advertiser. As shown in FIG. 3, by way of example, the presentation of advertiser information on the search results page 300 is determined by the share of marketing presence and/or marketing opportunities 304 allocated to a given search query 306 (or search query combination) by each of the advertisers. By way of a further example, if for a given search query (entered by a user) there were five eligible advertisers each having a 20% share of marketing presence and/or marketing opportunities, then the advertising server would (as a function of the program instructions 118) manage the display of advertiser information on the search results page 300 according to the respective shares of marketing presence and/or marketing opportunities to ensure that the advertiser information of each advertiser was presented to 20% of users of the digital advertising portal. It is preferable that the advertising information of a single advertiser will persist within a given search result set for the entire duration of the user's session on the digital advertising portal. However, it should be appreciated that the actual content of the advertiser information may vary to include, for example, various real estate agent profiles, various popular classified listings associated with that advertiser, and general promotional materials for that advertiser.

In addition to the share of advertising space on the digital advertising portal, the share of marketing presence and/or marketing opportunities allocated to an advertiser may also influence the share of advertising frequency including, for example, the number of times that the advertising and/or marketing information of a given advertiser is presented to users accessing the digital advertising portal. The duration of advertising time allocated to the advertiser may represent the overall advertising time allocated to an advertiser within a given time period, and/or advertising time allocated to an advertiser within a given user session on the digital advertising portal (such as described above in relation to FIG. 3).

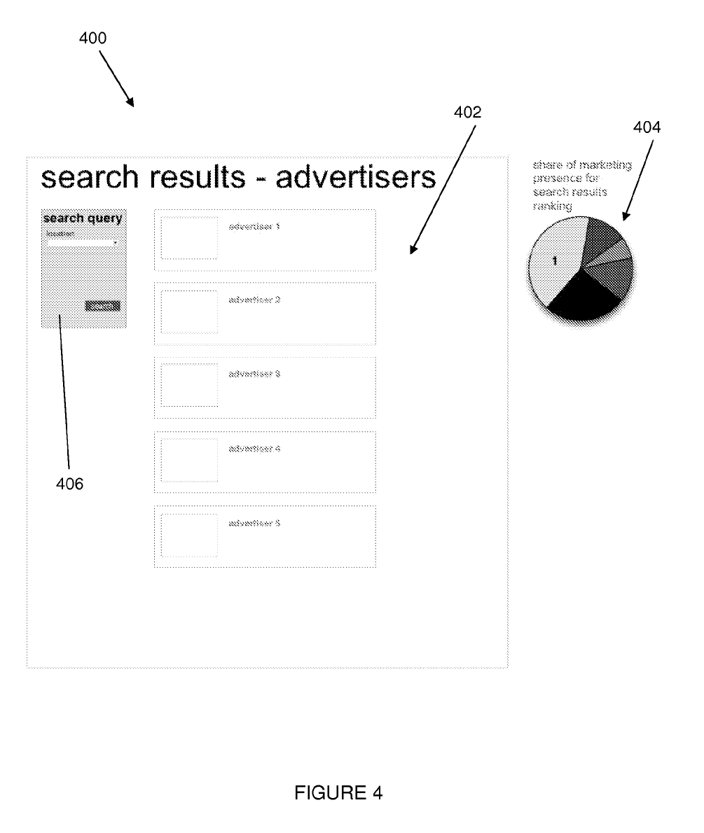

The share of marketing presence and/or marketing opportunities may also influence the search ranking of the classified listings associated with an advertiser (i.e. the search results order relevancy). For example, and assuming two or more similar classified listings, the classified listings associated with an advertiser having a greater share of marketing presence and/or marketing opportunities will rank higher in search results than the classified listings associated with an advertiser having a lower share of marketing presence and/or marketing opportunities. Alternatively, the share of marketing presence and/or marketing opportunities may also influence advertiser directory search results order relevancy (e.g. pursuant to a real estate agent search within a given search query). In a further example, the share of marketing presence and/or marketing opportunities may influence the ranking of various advertisers, following a search by a user, with classified listings being grouped based upon the advertiser that placed the classified listing. As shown in FIG. 4, by way of example, the presentation of advertiser information on an advertiser search results page 400, in response to a real estate agent/agency search, is based upon a ranking 402 of the advertisers that is determined by the share of marketing presence and/or marketing opportunities 404 allocated to a given search query 406 (or search query combination) by each of the advertisers. The ranking of the advertisers, based upon their share of marketing presence and/or marketing opportunities, influences the order in which they appear in the search results.

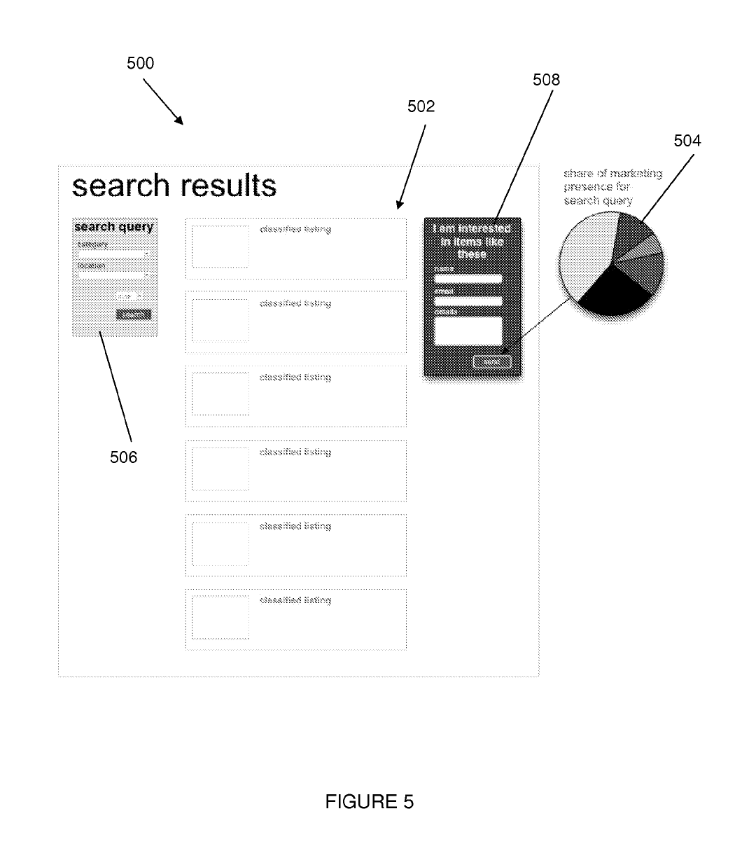

While not necessarily the result of users accessing the digital advertising portal to conduct searching for marketable commodities, the share of marketing presence and/or marketing opportunities may also influence the share of potential consumer leads allocated to an advertiser. For example, if the digital advertising portal allows users to register an interest in present or forthcoming real estate properties that align with a given search query, then the contact details of such users may be provided to advertisers based upon their respective share of marketing presence and/or marketing opportunities. An example of such operation is shown in FIG. 5, wherein after receiving a search query 506 for a real estate property, the user is presented with a search results page 500 including a number of classified listings 502 matching the search query 506, and an interest notification tool 508 which allows a user to enter their contact details (e.g. name, email address, and contact details) if they would like to be contacted regarding further real estate properties that match the search query submitted. Alternatively, and by way of further example, a vendor may register an interest in selling or leasing a real estate property by providing their contact details (e.g. name, email address, and contact details) and preferably property details. The contact details and/or property details can then be provided to advertisers based upon their respective share of marketing presence and/or marketing opportunities.

The allocation of user details to advertisers is based upon the search query entered by the user and also the respective shares of marketing presence and/or marketing opportunities allocated to that search query (or search query combination) by advertisers. Returning to the earlier example, if for a given search query (entered by a user) there were five eligible advertisers each having a 20% share of marketing presence and/or marketing opportunities, then the server 102 would (as a function of the program instructions 118) manage the allocation of user details received through the interest notification tool 508 (on the search results page 500) according to the respective shares of marketing presence and/or marketing opportunities to ensure that each advertiser receives 20% of the user enquiries received via the digital advertising portal.

In order to illustrate the method of allocating to advertisers of real estate properties a share of marketing presence and/or marketing opportunities on a digital advertising portal, in accordance with a representative embodiment of the present invention, the following detailed example is provided. The example is based upon an initial search query received from a user via the digital advertising portal, the search query specifying ‘Location A’ as the desired location, and ‘Price Band 7’ as the desired range of listing prices for the real estate property. The classified listings identified by the search query submitted on the digital advertising portal are identified below in Table 2.1:

TABLE 2.1

| | Price | | | | | Consumer Interest |
|---|---|---|---|---|---|---|
| Location | Band | Listing ID | Advertiser | Upgrade A | Upgrade B | Weighting Amount |
| Location A | 7 | 5404847 | Customer D | Level 2 | Level 2 | 0.69 |
| Location A | 7 | 3462383 | Customer D | Level 1 | Level 1 | 0.91 |
| Location A | 7 | 6462879 | Customer C | Base | Base | 0.61 |
| Location A | 7 | 2336111 | Customer E | Level 1 | Level 2 | 0.88 |
| Location A | 7 | 1012642 | Customer B | Base | Base | 0.24 |
| Location A | 7 | 5039517 | Customer E | Base | Base | 0.02 |
| Location A | 7 | 1959394 | Customer C | Level 1 | Level 3 | 0.76 |
| Location A | 7 | 7032603 | Customer C | Level 3 | Level 2 | 0.37 |
| Location A | 7 | 5789652 | Customer C | Base | Base | 0.85 |
| Location A | 7 | 2397169 | Customer E | Base | Base | 0.62 |
| Location A | 7 | 1245292 | Customer C | Level 1 | Level 2 | 0.11 |

In order to calculate the listing value for each of the classified listings identified in Table 2.1, it is necessary to access from the database 114, the applicable volume weighting amount, listing upgrade weighting amount, a consumer interest weighting amount. While the specific details of the consumer interest weighting amount for each of the classified listings are provided in Table 2.1 (based on prior comparisons with similar real estate properties), the points applicable to each of Upgrade A and Upgrade B are provided in Table 2.2 and 2.3 respectively. Furthermore, the applicable weightings, including the volume weighting, upgrade weighting, Upgrade A weighting, Upgrade B weighting, listings upgrade weighting, and listings potential weighting are provided in Table 2.4.

TABLE 2.3

| Upgrade B Level | Points |
|---|---|
| Base | 0 |
| Level 1 | 1 |
| Level 2 | 2 |
| Level 3 | 3 |

TABLE 2.2

| Upgrade A Level | Points |
|---|---|
| Base | 0 |
| Level 1 | 1 |
| Level 2 | 5 |
| Level 3 | 15 |

TABLE 2.4

| Weighting Type | Weighting Value |
|---|---|
| Volume Weighting | 1.0 |
| Upgrade Weighting | 1.0 |
| Upgrade A Weighting | 1.0 |
| Upgrade B Weighting | 1.0 |
| Listings Upgrade Weighting | 1.0 |
| Listings Potential Weighting | 0.0 |
| Consumer Index Weighting | 1.0 |

The calculation of the listing value for each of the classified listings identified in Table 2.1 can then performed in accordance with Formula 1 (as specified above). By way of example, the calculation of the listing value for the classified listing having the ‘Property ID’ 5404847 (i.e. the first classified listing shown in Table 2.1) is shown below in Table 2.5:

TABLE 2.5

| Listing Value | | |
|---|---|---|
| Formula Components | Result | Comments |
| (1 × volume weighting) | 1 × 1 = 1 | There is a listing |
| (1 × upgrade weighting) | 1 × 1 = 1 | The property has been |
| | | upgraded |
| (Upgrade A value × | 5 × 1 = 5 | Upgrade A (Level 2) |
| Upgrade A weighting) | | has been purchased |
| (Upgrade B value × | 2 × 1 = 2 | Upgrade B (Level 2) |
| Upgrade B weighting) | | has been purchased |
| (1 + Consumer | (1 + 0.69) * 1 = 1.69 | |
| Interest Value) × | | |
| Consumer Interest | | |
| Weighting) | | |
| Listing Value | 15.21 | |

The calculated listing values for each of the classified listings, as calculated in accordance with Formula 1, are shown below in Table 2.6.

TABLE 2.6

| Listing ID | Advertiser | Listing Value |
|---|---|---|
| 5404847 | Customer D | 15.21 |
| 3462383 | Customer D | 7.64 |
| 6462879 | Customer C | 1.61 |
| 2336111 | Customer E | 9.40 |
| 1012642 | Customer B | 1.24 |
| 5039517 | Customer E | 1.02 |
| 1959394 | Customer C | 10.56 |
| 7032603 | Customer C | 26.03 |
| 5789652 | Customer C | 1.85 |
| 2397169 | Customer E | 1.62 |
| 1245292 | Customer C | 5.55 |

After the calculation of the listing values for each of the classified listings identified in Table 2.1, it is then possible to calculate the advertiser value for each of the advertisers associated with these classified listings (i.e. Customer B, Customer C, Customer D and Customer E). To determine the advertiser value for each of the advertisers, the first step involves calculating the total of all listing values for classified listings associated with a given advertiser. For example, Table 2.6 illustrates that Customer D has two listings, namely Listing ID 5404847 and Listing ID 3462383. The total of all listing values for classified listings associated with Customer D is calculated by adding the listing value of Listing ID 5404847 (namely 15.21) to the listing value of Listing ID 3462383 (namely 7.64). Therefore, the combined listing value for Customer D is 22.85. By performing a similar aggregation of listing values, the provisional advertiser values for each of the remaining advertisers can be calculated (as shown in Table 2.7 below).

TABLE 2.7

| Advertiser | # Listings | Advertiser Value |
|---|---|---|
| Customer B | 1 | 1.24 |
| Customer C | 5 | 45.60 |
| Customer D | 2 | 22.85 |
| Customer E | 3 | 12.04 |
| TOTAL | 11 | 81.73 |

In accordance with Formula 2 (as described above), the advertiser value for each of the advertisers is then adjusted based upon the proportion of classified listings that have been upgraded (beyond the base level of upgrade), and based upon the level of upgrade of the classified listings relative to the maximum potential upgrade available. For example, and as illustrated in Table 2.1, Customer C has a total of five classified listings, but only three of these listings have been upgraded beyond the base level. As such, it is determined that 60% of the classified listings associated with Customer C have been upgraded. Based upon this calculation of the upgrade proportion, the advertiser value for Customer C is increased by an additional 60% of the advertiser value (based upon an upgrade weighting of 1), as shown in Table 2.4.

Using the Upgrade points for Upgrade A and Upgrade B, shown in Table 2.2 and Table 2.3 respectively, it is then possible to determine for Customer C the level of upgrade of the classified listings relative to the maximum potential upgrade available. Given that Customer C has a total of five classified listings, the maximum potential upgrade available is 90 points (i.e. Maximum Upgrade A of 15 points+Maximum Upgrade B of 3, for each of the listings). However, the total points earned through upgrades for Customer C (as identified by Tables 2.1 to 2.3) is 23. Expressed as a percentage of the maximum potential upgrade available, the points earned by Customer C represent 26% (i.e. 23 out of 90). This percentage can then be applied to the provisional advertiser value for Customer C, by increasing the provisional advertiser value by an additional 26% of the advertiser value. However, in this instance, the listing potential weighting is 0 and, as such, no further adjustment of the provisional advertiser value is performed. By performing similar calculations, the adjusted and finalised advertiser values for each of the remaining advertisers can be calculated (as shown in Table 2.8 below).

TABLE 2.8

| Advertiser | # Listings | Upgraded | Adjustment | Advertiser Value |
|---|---|---|---|---|
| Customer B | 1 | 0 | 0% | 1.24 |
| Customer C | 5 | 3 | 60% | 72.96 |
| Customer D | 2 | 2 | 100% | 45.70 |
| Customer E | 3 | 1 | 33% | 16.05 |
| TOTAL | 11 | 6 | 55% | 135.95 |

Finally, and based upon the adjusted advertiser values for each of the advertisers (as shown in Table 2.8), it is then possible to determine the share of marketing presence and/or marketing opportunities to be allocated to each of the advertisers. The share of marketing presence and/or marketing opportunities for each advertiser is determined by comparing the advertiser value to the total of all the advertiser values for all advertisers. For example, the share of marketing presence and/or marketing opportunities for Customer D is 33.6% since the advertiser value for Customer D is 45.70, and the total of all advertiser values is 135.95. By performing similar calculations, the share of marketing presence and/or marketing opportunities for each of the remaining advertisers can be calculated (as shown in Table 2.9 below).

TABLE 2.9

| | | Share of Marketing |
|---|---|---|
| Advertiser | Advertiser Value | Presence |
| Customer B | 1.24 | 0.9% |
| Customer C | 72.96 | 53.67% |
| Customer D | 45.70 | 33.62% |
| Customer E | 16.05 | 11.80% |
| TOTAL | 135.95 | 100.00% |

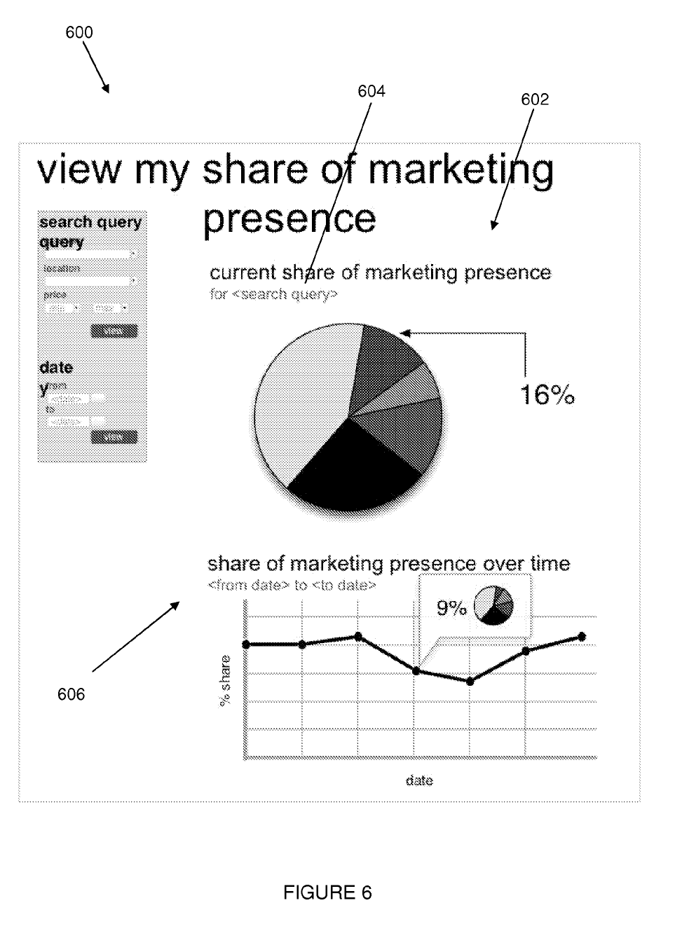

Following the allocation of a share of marketing presence and/or marketing opportunities to advertisers, a representative embodiment of the present invention also allows advertisers to manage their share of marketing presence and/or marketing opportunities allocation. By accessing the digital advertising portal (and preferably entering an individualised username and password), an advertiser will be presented with a marketing presence and/or marketing opportunities reporting screen 600, such as shown in FIG. 6 of the drawings. From this screen 600, the advertiser is able to view their current share of marketing presence and/or marketing opportunities 602 as it relates to one or more search queries (or combinations) 604. The advertiser may also be presented with historical marketing presence and/or marketing opportunities data 606 (preferably in graphical form), which illustrates how the advertiser's share of marketing presence and/or marketing opportunities has fluctuated over a given period of time.

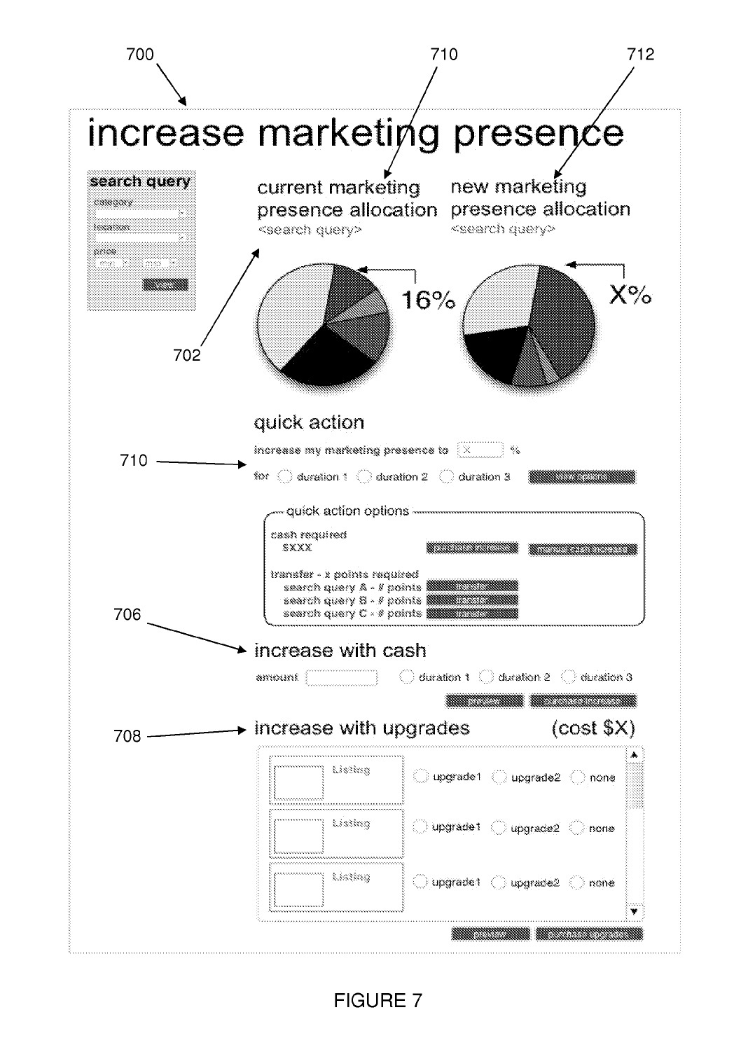

A further option available to advertisers is the ability to increase their share of marketing presence and/or marketing opportunities on the digital advertising portal. Advertisers can increase their share of marketing presence and/or marketing opportunities by either purchasing upgrades for one or more of their classified listings, or through cash purchases of ‘points’, which can then assigned to one or more search queries (or combinations). An example of a marketing share increase screen 700 that is displayed to advertisers is shown at FIG. 7 of the drawings. From this screen 700, an advertiser is presented with options for increasing their share of marketing presence and/or marketing opportunities in relation to one or more search queries (or combinations) 702, through either a cash increase option 704 or a upgrade purchase option 706. If an advertiser wishes to increase their share of marketing presence and/or marketing opportunities through the cash increase option 704, then they can enter a cash amount and preview how this amount will influence their share of marketing presence and/or marketing opportunities before confirming the purchase. The screen 700 also provides a visual comparison of the current share of marketing presence and/or marketing opportunities 710 to the adjusted share of marketing presence and/or marketing opportunities 712, following the purchase by the advertiser. As opposed to entering a specific cash amount, and in an alternate embodiment of the present invention, the advertiser can set the desired share of marketing presence and/or marketing opportunities and then be presented with the cash amount required in order to achieve that desired share of marketing presence and/or marketing opportunities.

While not shown on screen 700, it may also be possible for an advertiser to specify the duration of their cash purchases, and the alignment with upgrade product durations. For example, a cash purchase applied over a short period of time will have greater impact on the advertiser's share of marketing presence and/or marketing opportunities (though for a shorter duration), than applying the cash purchase over a longer period of time. In a representative embodiment of the present invention, a tariff is preferably applied to cash purchases made through the cash increase option 704. This tariff is applied in accordance with a system-configurable sliding scale (as determined by the digital advertising portal) based upon the percentage of an advertiser's classified listings for which an upgrade has been purchased. For example, if an advertiser has a low percentage of upgrades applied to their classified listings, they will be charged a high tariff for cash purchases than an advertiser having a higher percentage of upgrades applied to their classified listings.

If an advertiser wishes to increase their share of marketing presence and/or marketing opportunities by upgrading one or more of their classified listings (through the upgrade purchase option 706), then they can select one or more upgrades (at one or more different upgrade levels) to be applied to their classified listings and preview how these upgrades will influence their share of marketing presence and/or marketing opportunities before confirming the purchase. Once again, the screen 700 provides a visual comparison of the current share of marketing presence and/or marketing opportunities 710 to the adjusted share of marketing presence and/or marketing opportunities 712, following the purchase of selected upgrades by the advertiser. As opposed to selecting specific upgrades to classified listings, and in an alternate embodiment of the present invention, the advertiser can set the desired share of marketing presence and/or marketing opportunities and then be presented with recommended upgrades that, if purchased, would result in the desired share of marketing presence and/or marketing opportunities.

It should be appreciated that from screen 700, it is possible for an advertiser to increase their share of marketing presence and/or marketing opportunities in relation to one or more search queries (or combinations) 702, by selecting the cash increase option 704, the upgrade purchase option 706, or any combination of these options 704 and 706. Furthermore, and in a representative embodiment of the present invention, the screen 700 may also provide a number of pre-selected options 710 to allow an advertiser to quickly increase their share of marketing presence and/or marketing opportunities. Such options 710 may allow an advertiser to specify a desired percentage of marketing presence and/or marketing opportunities, and be presented with various options (including cash purchases and/or transfer options) for achieving that desired percentage or share of marketing presence and/or marketing opportunities.

In order to illustrate how an advertiser request to increase their share or marketing presence and/or marketing opportunities may be processed by the digital advertising portal, the following brief examples are provided. These examples are based upon the existing share of marketing presence and/or marketing opportunities allocations shown in Table 2.9 above. If Customer E wanted to increase their 11.80% share of marketing presence and/or marketing opportunities allocation for the same location and price band (i.e. ‘Location A’ as the desired location, and ‘Price Band 7’ as the desired range of listing prices for the real estate property) then they would have the options of upgrading any of their base level classified listings, upgrading any of the currently-upgraded classified listings to a higher upgrade level, or purchasing addition ‘points’. However, if the advertiser did not want to upgrade any of their existing classified listings, or if their existing classified listings had already been upgraded to their maximum potential, then the only option available to the advertiser would be to purchase ‘points’ via the cash increase option 704 on screen 700.

By way of further example, if Customer B wanted to increase their share of marketing presence and/or marketing opportunities but was limited by the number of classified listings they had in a particular search query category (i.e. a particular location and price band), then they would have the option of purchasing ‘points’ via the cash increase option 704 on screen 700. If Customer B were to purchase an additional 10 ‘points’, thus increasing their advertiser value from 1.24 to 11.24, then their share of marketing presence and/or marketing opportunities would increase from 0.9% to 7.7% (after a re-calculation of the share of marketing presence and/or marketing opportunities allocations). The increase in the share of marketing presence and/or marketing opportunities allocated to Customer B consequentially results in decreases to the respective shares of marketing presence and/or marketing opportunities allocated to the remaining advertisers. The re-calculated allocations of shares of marketing presence and/or marketing opportunities to the remaining advertisers, as a result of the increase to the share of marketing presence and/or marketing opportunities allocated to Customer B, is shown in Table 2.10 below.

TABLE 2.10

| | | Share of Marketing |
|---|---|---|
| Advertiser | Advertiser Value | Presence |
| Customer B | 11.24 | 7.7% |
| Customer C | 72.96 | 50.0% |
| Customer D | 45.70 | 31.3% |
| Customer E | 16.05 | 11.0% |
| TOTAL | 145.95 | 100.00% |

In the example described above, Customer B was able to increase their share of marketing presence and/or marketing opportunities in relation to a search query category (i.e. a particular location and price band) where they may not have currently had much market share, since the default calculation of the share of marketing presence and/or marketing opportunities is based upon the number of classified listings that aligned with a given search query. As a result of the increase in the share of marketing presence and/or marketing opportunities, Customer B would gain increased exposure in their desired search category.

A still further option available to advertisers is the ability to transfer their share of marketing presence and/or marketing opportunities (or any portion thereof) between any of the search query categories (i.e. a particular location and price band) in order to focus their share of marketing presence and/or marketing opportunities in their preferred search query categories. Using an example relating to automobiles, an advertiser who sells Toyota branded vehicles, and amongst those Toyota Land Cruisers (a 4-wheel drive vehicle) would, by default, be allocated a share of marketing presence and/or marketing opportunities within Toyota and Toyota Land Cruiser searches submitted via the digital advertising portal. However, the advertiser may wish to transfer some of their default share of marketing presence and/or marketing opportunities allocation to another 4-wheel drive vehicle search query category, in order to promote their brand and/or to promote classified listings of Toyota Land Cruisers to users of the digital advertising portal that are searching for similar vehicles.

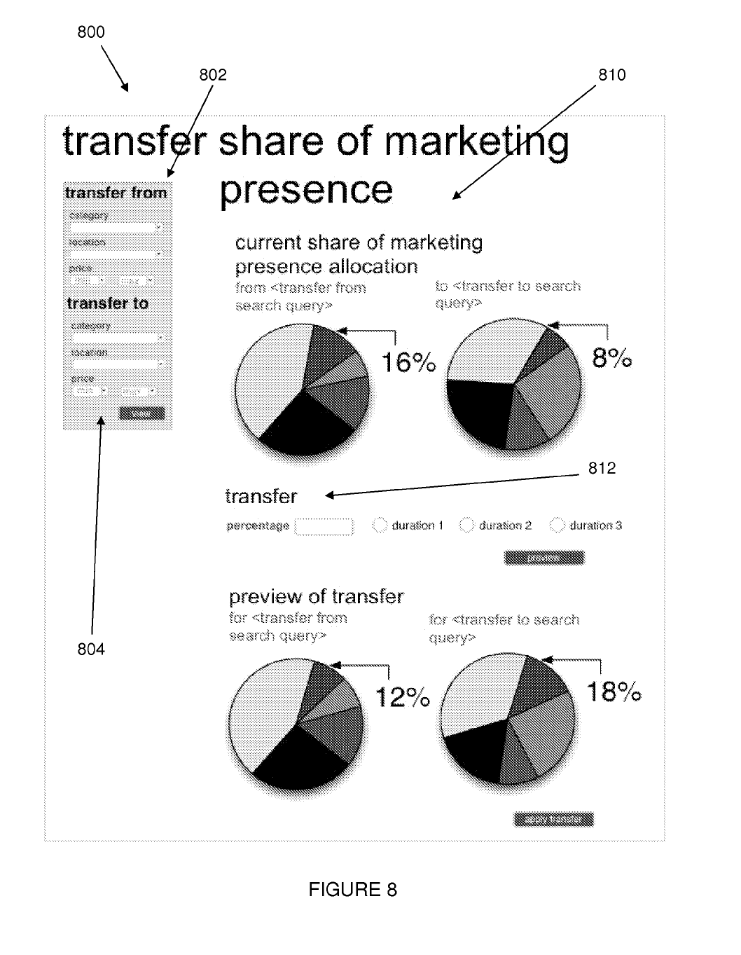

An example of a marketing share transfer screen 800 that is displayed to advertisers is shown at FIG. 8 of the drawings. From this screen 800, an advertiser is presented with options for transferring their current share of marketing presence and/or marketing opportunities (or a portion thereof) between two or more search queries (or combinations) 802 and 804. The advertiser preferably enters the percentage of the current share of marketing presence and/or marketing opportunities that they wish to transfer from one search query 802 to another search query 804, and can preview the influence of the transfer before confirming the transfer. In a representative embodiment of the present invention, a tariff is preferably applied to transfers of share of marketing presence and/or marketing opportunities made between search queries (or combinations). This tariff is may be applied in accordance with a system-configurable sliding scale (as determined by the digital advertising portal) or based upon a fixed system. By way of example, if an advertiser wishes to transfer 500 ‘points’ (from their default allocation of share of marketing presence and/or marketing opportunities) from ‘Location A’ to ‘Location B’, and the tariff for the transfer is 20%, then the share of marketing presence and/or marketing opportunities ‘points’ assigned to ‘Location B’ will be 400.

The screen 800 also provides a visual comparison of the current shares of marketing presence and/or marketing opportunities 810 for both the transferor and transferee search queries, together with the projected shares of marketing presence and/or marketing opportunities 812 for both the transferor and transferee search queries, following the transfer by the advertiser (and taking into consideration any applicable tariffs for the transfer). The advertiser can then make a decision whether to complete the transfer.

In accordance with a representative embodiment of the present invention, advertisers also have the ability to manage and customize the display of their classified listings on the digital advertising portal. For example, advertisers have the option of customizing their advertising content on the digital advertising portal by modifying colours, text, and/or images. In addition, it may be possible to customize the presentation of classified listings based upon different search query dimensions. For example, text and images associated with advertiser content may be programmed to vary depending upon the search query (or combination) input by the user of the digital advertising portal (e.g. different locations, classifications, or ranges of listing prices).

Furthermore, an advertiser preferably has the option to set various notifications on the digital advertising portal. For example, an advertiser may wish to be notified automatically by the digital advertising portal when their share of marketing presence and/or marketing opportunities increases or decreases (beyond a threshold amount predefined by the advertiser) so that they can keep abreast of changes and manage their share of marketing presence and/or marketing opportunities accordingly.

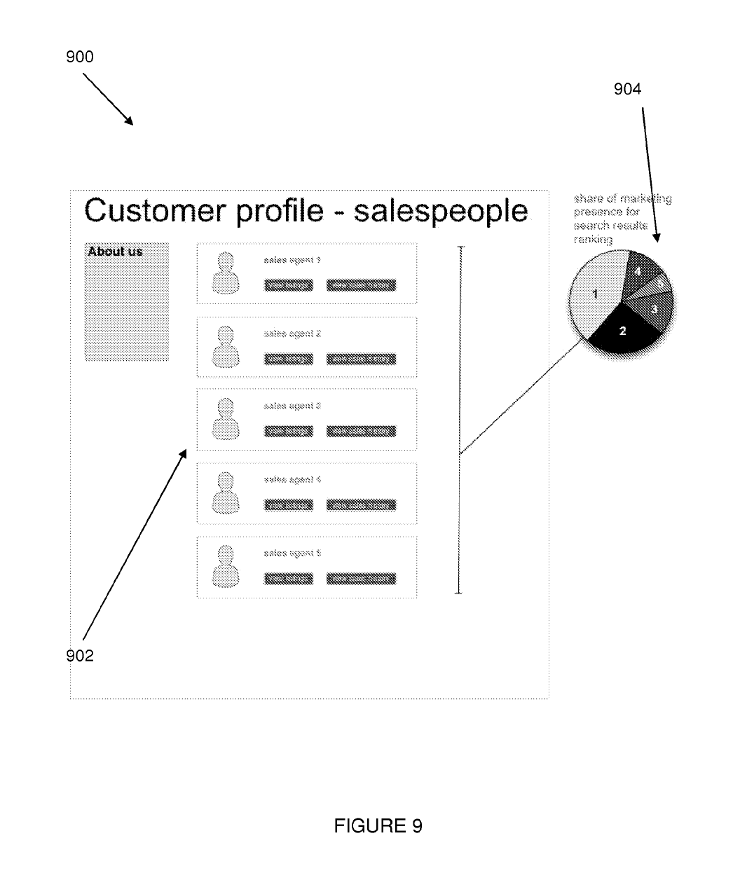

In addition to the broader allocation to advertisers of a share of marketing presence and/or marketing opportunities, a representative embodiment of the present invention also allows for the allocation of a share of marketing presence to individual real estate agents within a given advertiser (i.e. real estate agency). After calculating an advertiser's share of marketing presence and/or marketing opportunities in accordance with the method described above, it is then possible to segment and allocate this share of marketing presence and/or marketing opportunities amongst individual real estate agents within an agency. This allocation of marketing presence and/or marketing opportunities to individual real estate agents is performed using the same calculation metrics as previously described. This allocation of marketing presence and/or marketing opportunities can then be used to advertise or promote leading real estate agents (e.g. those with the largest share of marketing presence and/or marketing opportunities) within the advertising ‘space’ of the agency. For example, a real estate agency may use a portion of its available advertising space on the digital advertising portal to promote its real estate agents through the use of profile presentations. Alternatively, the allocation of marketing presence and/or marketing opportunities may be used by the real estate agency to rank individual real estate agents on an agency profile page 900, such as shown in FIG. 9 of the drawings. It is preferable that real estate agencies (at a management level) can access their agency profile page 900 and obtain a ranking 902 of individual real estate agents within that agency, as well as an indication of the agency's current share of marketing presence and/or marketing opportunities 904.

As previously described, the invention is particularly useful in relation to allocating to advertisers of real estate property a share of marketing presence and/or marketing opportunities on a digital advertising portal, and it will therefore be convenient to describe the invention in that environment. However, it should be understood that the invention is not limited to this preferred embodiment, and may be implemented in other environments such, for example, automobile and boating sales, and employment opportunities. For example, in an alternative embodiment of the present invention relating to allocating to advertisers of motor vehicles a share of marketing presence and/or marketing opportunities on a digital advertising portal, the search criteria (and corresponding commodity descriptors) available to users of the digital advertising portal preferably include one or more of:
a desired category of vehicle such as, for example, a new vehicle, dealer used or demonstration vehicle, or private vehicle;
a desired location of the vehicle such as, for example, the postcode, suburb, region and/or state in which the vehicle is located;
a desired range of advertised sale/purchase prices including, for example, minimum and maximum desired sales price for the vehicle;
a desired vehicle make such as, for example, Ford, Mazda, Toyota, Volkswagen etc.; and
a desired vehicle model (as a subset of the vehicle make) such as, for example, Ford->Focus, Mazda->RX8, Toyota->Land Cruiser, Volkswagen->Passat etc.

By way of further example, in an alternative embodiment of the present invention relating to allocating to advertisers of careers and employment opportunities a share of marketing presence and/or marketing opportunities on a digital advertising portal, the search criteria (and corresponding commodity descriptors) available to users of the digital advertising portal preferably include one or more of:
a desired category of employment opportunity such as, for example, full time, part time, or contract employment;
a desired location of the employment position such as, for example, the postcode, suburb, region and/or state in which the employment position is located;
a desired price salary band including, for example, minimum and maximum desired salary for an employment position;
a desired employment industry sector such as, for example, Accounting, Banking and Financial Services, Manufacturing, Construction etc.; and
a desired employment role such as, for example, Electrician, CEO, Project Manager, Butcher, Carpenter etc.

The word ‘comprising’, and forms of the word ‘comprising’, when used in this specification is taken to specify the presence of stated features, integers, steps or components but does not preclude the presence or addition of one or more other features, integers, steps, components or groups thereof.

As the present invention may be embodied in several forms without departing from the essential characteristics of the invention, it should be understood that the above described embodiments should not be considered to limit the present invention but rather should be construed broadly. Various modifications, improvements and equivalent arrangements will be readily apparent to those skilled in the art, and are intended to be included within the spirit and scope of the invention.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

1. A computer-implemented method of allocating to advertisers of marketable commodities on a digital advertising portal a share of marketing presence and/or marketing opportunities, said method comprising the steps of:
(a) receiving from each of said advertisers one or more classified listings corresponding to marketable commodities, said classified listings including one or more commodity descriptors to allow for identification of said marketable commodities;
(b) calculating for each of said classified listings a listing value, said listing value being based upon at least one listing weighting associated with said classified listing;
(c) calculating for each of said advertisers at least one advertiser value, said advertiser value being based upon at least one or more of said listing values for classified listings associated with said advertiser; and
(d) determining for each of said advertisers a share of marketing presence and/or marketing opportunities on said digital advertising portal, said share of marketing presence and/or marketing opportunities being based upon at least said advertiser value.

2. The method according to claim 1, wherein said marketable commodities are real estate properties.

3. The method according to claim 2, wherein said commodity descriptors include one or more of:
(a) a location of said real estate property;
(b) a classification of said real estate property; and
(c) a listing price for said real estate property.

4. The method according to either claim 2 or claim 3, wherein step (c) includes the preliminary step of determining one or more search queries available to users of said digital advertising portal for identifying relevant marketable commodities.

5. The method according to claim 4, wherein said search queries available to said users include one or more of:
(a) a desired property location;
(b) a desired property classification; and
(c) a desired range of property listing prices.

6. The method according to either claim 4 or claim 5, wherein for each of said advertisers step (c) includes calculating an advertiser value corresponding to each of said search queries, said advertiser value being based upon at least one or more of said listing values for a subset of classified listings associated with said advertiser.

7. The method according to claim 6, wherein said advertiser value is based upon a total of all said listing values for said subset of classified listings associated with said advertiser.

8. The method according to either claim 6 or claim 7, wherein said subset of classified listings includes those classified listings associated with said advertiser that are also identifiable by said search query.

9. The method according to any one of claims 6 to 8, wherein said subset of classified listings is determined based upon at least a comparison of said search query with said commodity descriptors for each of said classified listings.

10. The method according to any one of claims 2 to 9, wherein the at least one listing weighting is based upon one or more of the following:
(a) a volume weighting amount;
(b) a listing upgrade weighting amount; and
(c) a consumer interest weighting amount.

11. The method according to claim 10, wherein said consumer interest weighting amount is based upon performance data of comparable classified listings.

12. The method according to any one of claims 2 to 11, wherein said advertiser value is also based upon one or more of:
(a) a maximum potential listing value for one or more classified listings associated with said advertiser;
(b) an amount of purchased advertiser value associated with said advertiser; and
(c) an amount of transferred advertiser value associated with said advertiser.

13. The method according to any one of claims 2 to 12, wherein for each of said advertisers said share of marketing presence and/or marketing opportunities is also based upon a comparison of said advertiser value with a total of the advertiser values for all of said advertisers.

14. The method according to any one of claims 2 to 13, wherein for each of said advertisers the determination of said share of marketing presence and/or marketing opportunities is repeated at predefined time intervals.

15. The method according to any one of claims 2 to 13, wherein for each of said advertisers the determination of said share of marketing presence and/or marketing opportunities is performed dynamically.

16. The method according to any one of claims 4 to 15, wherein for each of said advertisers said share of marketing presence and/or marketing opportunities influences one or more of:
(a) a share of advertising space allocated to said advertiser on said digital advertising portal;
(b) a share of advertising frequency allocated to said advertiser on said digital advertising portal;
(c) a duration of advertising time allocated to said advertiser on said digital advertising portal;
(d) a search ranking of said classified listings associated with said advertiser relative to classified listings associated with other advertisers; and
(e) a share of potential consumer leads allocated to said advertiser.

17. A computer-implemented system of allocating to advertisers of marketable commodities on a digital advertising portal a share of marketing presence and/or marketing opportunities, said system comprising:
(a) means for receiving from each of said advertisers one or more classified listings corresponding to marketable commodities; said classified listings including one or more commodity descriptors to allow for identification of said marketable commodities;
(b) means for calculating for each of said classified listings a listing value, said listing value being based upon at least a listing weighting associated with said classified listing;
(c) means for calculating for each of said advertisers at least one advertiser value, said advertiser value being based upon at least one or more of said listing values for classified listings associated with said advertiser; and
(d) means for determining for each of said advertisers a share of marketing presence and/or marketing opportunities on said digital advertising portal, said share of marketing presence and/or marketing opportunities being based upon at least said advertiser value.

18. The system according to claim 17, wherein said marketable commodities are real estate properties.

19. A computer-implemented method of determining the composition of advertising information presented to users of a digital advertising portal, said advertising portal comprising advertising information relating to one or more marketable commodities, said method comprising the steps of:
(a) receiving from each of said advertisers one or more classified listings corresponding to marketable commodities; said classified listings including one or more commodity descriptors to allow for identification of said marketable commodities;
(b) determining one or more search queries available to said users of said digital advertising portal for identifying relevant marketable commodities;
(c) receiving from at least one of said users a search request, said search request including at least one of said search queries available to said users;
(d) allocating to each of said advertisers a share of advertising presence on said digital advertising portal, said share of advertising presence being based upon at least said classified listings received from said advertiser; and
(e) presenting to each of said users a selection of advertising information, said advertising information being based upon said share of advertising presence allocated to each of said advertisers and/or said search request.

20. The method according to claim 19, wherein said marketable commodities are real estate properties.

21. The method according to claim 20, wherein step (d) includes the preliminary steps of:
(a) calculating for each of said classified listings a listing value, said listing value being based upon at least a listing weighting associated with said classified listing; and
(b) calculating for each of said advertisers at least one advertiser value, said advertiser value being based upon at least one or more of said listing values for classified listings associated with said advertiser.

22. The method according to claim 21, wherein for each of said advertisers said share of advertising presence is based upon at least said advertiser value.

23. The method according to either claim 21 or claim 22, wherein said search queries available to said users include one or more of:
(a) a desired property location;
(b) a desired property classification; and
(c) a desired range of property listing prices.

24. The method according to any one of claims 21 to 23, wherein for each of said advertisers said step of calculating at least one advertiser value includes calculating an advertiser value corresponding to at least the search query contained in said search request.

25. The method according to claim 24, wherein said advertiser value is based upon a total of all said listing values for said subset of classified listing associated with said advertiser.

26. The method according to either claim 24 or claim 25, wherein said subset of classified listings includes those classified listings associated with said advertiser that are also identifiable by said search request.

27. The method according to claim 26, wherein said subset of classified listings is determined based upon at least a comparison of said search query with said commodity descriptors for each of said classified listings.

28. The method according to any one of claims 21 to 27, wherein said advertiser value is also based upon one or more of:
(a) a maximum potential listing value for one or more classified listings associated with said advertiser;
(b) an amount of purchased advertiser value associated with said advertiser; and
(c) an amount of transferred advertiser value associated with said advertiser.

29. The method according to any one of claims 21 to 28, wherein for each of said advertisers said share of advertising presence is also based upon a comparison of said advertiser value with a total of all advertiser values for said advertisers.

30. The method according to any one of claims 20 to 29, wherein for each of said advertisers said share of advertising presence influences one or more of:
(a) a share of advertising space allocated to said advertiser on said digital advertising portal;
(b) a share of advertising frequency allocated to said advertiser on said digital advertising portal;
(c) a duration of advertising time allocated to said advertiser on said digital advertising portal; and
(d) a search ranking of said classified listings associated with said advertiser relative to classified listings associated with other advertisers.

31. The method according to any one of claims 20 to 30, wherein said selection of advertising information presented to said users includes either:
(a) classified listings and/or marketing information associated with only one of said advertisers; or
(b) classified listings and/or marketing information associated with two or more of said advertisers.

32. The method according to any one of claims 20 to 31, wherein said selection of advertising information is presented to said user for the duration of a user session.

33. A computer-implemented method of allowing advertisers of marketable commodities to manage a share of marketing presence and/or marketing opportunities on a digital advertising portal, said method comprising the steps of:
(a) receiving from each of said advertisers one or more classified listings corresponding to marketable commodities; said classified listings including one or more commodity descriptors to allow for identification of said marketable commodities;
(b) allocating to each of said advertisers a share of marketing presence and/or marketing opportunities on said digital advertising portal, said share of marketing presence and/or marketing opportunities being based upon at least said classified listings received from said advertiser;
(c) presenting to one or more of said advertisers marketing share data, said marketing share data being representative of said share of marketing presence and/or marketing opportunities allocated to said advertiser; and
(d) receiving a request from one or more of said advertisers to modify said share or marketing presence and/or marketing opportunities on said digital advertising portal.

34. The method according to claim 33, wherein said marketable commodities are real estate properties.

35. The method according to claim 34, wherein step (b) includes the preliminary steps of:
(a) calculating for each of said classified listings a listing value, said listing value being based upon at least a listing weighting associated with said classified listing; and
(b) calculating for each of said advertisers at least one advertiser value, said advertiser value being based upon at least:
(i) one or more of said listing values for classified listings associated with said advertiser; and/or
(ii) one or more search queries available to users of said digital advertising portal for identifying relevant marketable commodities.

36. The method according to claim 36, wherein for each of said advertisers said share of marketing presence and/or marketing opportunities is based upon at least said advertiser value.

37. The method according to either claim 35 or claim 36, wherein said advertiser value is also based upon one or more of:
(a) a maximum potential listing value for one or more classified listings associated with said advertiser;
(b) an amount of purchased advertiser value associated with said advertiser; and
(c) an amount of transferred advertiser value associated with said advertiser.

38. The method according to any one of claims 35 to 37, wherein for each of said advertisers said share of marketing presence and/or marketing opportunities is also based upon a comparison of said advertiser value with a total of all advertiser values for said advertisers.

39. The method according to either claim 37 or claim 38, wherein for each of said advertisers said request to modify said share or marketing presence and/or marketing opportunities includes one or more of:
(a) a request to increase said share of marketing presence and/or marketing opportunities by acquiring purchased advertiser value; and
(b) a request to modify a predefined association of said share of marketing presence and/or marketing opportunities with one or more search queries available to users of said digital advertising portal.

40. The method according to claim 39, wherein said request to modify said predefined association of said share of marketing presence and/or marketing opportunities results in one or more of:
(a) an increased association of said share of marketing presence and/or marketing opportunities with a first subset of said search queries; and
(b) a decreased association of said share of marketing presence and/or marketing opportunities with a second subset of said search queries.

41. The method according to any one of claims 37 to 40, wherein for each of said advertisers said share of marketing presence and/or marketing opportunities influences one or more of:
(a) a share of advertising space allocated to said advertiser on said digital advertising portal;
(b) a share of advertising frequency allocated to said advertiser on said digital advertising portal;
(c) a duration of advertising time allocated to said advertiser on said digital advertising portal; and
(d) a search ranking of said classified listings associated with said advertiser relative to classified listings associated with other advertisers.

42. A computer-implemented method of allocating to advertisers of marketable commodities on a digital advertising portal a share of marketing presence and/or marketing opportunities, said method comprising the steps of:
(a) receiving from each of said advertisers one or more classified listings corresponding to marketable commodities, said classified listings including one or more commodity descriptors to allow for identification of said marketable commodities; and
(b) allocating to each of said advertisers a share of marketing presence and/or marketing opportunities on said digital advertising portal, said share of marketing presence and/or marketing opportunities being based upon at least said classified listings received from said advertiser.

43. A computer-implemented system of allocating to advertisers of marketable commodities on a digital marketing portal a share of marketing presence and/or marketing opportunities, said system comprising one or more computers including:
at least one processor;
an interface between said processor and a data network;
a database for containing information relating to said marketable commodities; and
at least one storage medium operatively coupled to said processor, said storage medium containing program instructions for execution by said processor, said program instructions causing said processor to execute the steps of the method of any one of claims 1 to 16 or 19 to 42.

44. A tangible computer-readable medium having computer-executable instructions stored thereon for directing a programmable device to perform the method of any one of claims 1 to 16 or 19 to 42.
